(19) United States
(12) Patent Application Publication
(10) Pub. No.: US 2009/0030763 A1
(43) Pub. Date: Jan. 29, 2009

(54) Supplier compliance manager tool

(76) Inventor: Daniel J. Purtell, Mesa, AZ (US)

Correspondence Address: SHUMAKER LOOP & KENDRICK, 101 E. KENNEDY, SUITE 2800, TAMPA, FL, 33672-0609, US

(21) Appl. No.: 12/218,893

(22) Filed: Jul. 18, 2008

Related U.S. Application Data
(60) Provisional application No. 60/950,392, filed on Jul. 18, 2007.

(51) Int. Cl. G06Q 10/00

(52) U.S. Cl. 705/7

(57) ABSTRACT

The present invention provides a web-based module, including a risk calculating function, which facilitates the gathering and analyzing of supplier data for obtaining C-TPAT certification.

This claims priority to U.S. Provisional Application No. 60/950,392, filed on Jul. 18, 2007 and titled “SUPPLIER COMPLIANCE SYSTEM” and it is herein incorporated by reference.

### BACKGROUND

Industry is in the process of globalizing through connections with global suppliers, manufacturers and transporters (collectively “suppliers”). With the increase in globality comes an increasing role for foreign suppliers, transporters and manufacturers in providing the goods and services, many essential, that the people and institutions of the United States have come to depend upon.

With the dependence comes a vulnerability. The goods and services the U.S. has come to rely upon as a nation require the tight cooperation of many independent organizations. For example, many of the goods consumed by Americans are produced as a result of multiple coordinated steps: raw materials for parts are produced in many locations. These raw materials may then be transported from the site of production to a location where they are fabricated into components for use at a higher level of consumption. The parts themselves may require that multiple raw materials be transported to one location. Ultimately, the parts may be transported to yet another location where they are assembled with other parts into products. These products may undergo further transportation and assembly, or they may be transported to their intended market.

Any one of the production, transportation, manufacture and assembly steps which takes place outside the United States can represents a point of vulnerability. Social unrest, terrorist activities and other disruptions greatly threaten the web of production in that the jeopardization of a single raw material produce, a single part maker, a single assembler, etc. can dramatically affect the market for a given good, due to the ability to threaten the supply of the good. Each part of the chain of manufacture can represent a point of vulnerability.

The United States has addressed the problem of “pressure point” vulnerability by implementing an incentive-based voluntary certification initiative between Customs and companies: the Customs-Trade Partnership Against Terrorism (C-TPAT), which helps companies assess the vulnerabilities of their trading partners to terrorism, as well as, assess the company's own indirect vulerability. The incentives to certification include reduced waiting at borders and expedited inspections, etc.

More than 10,000 companies are currently enrolled in the U.S. C-TPAT program. This program establishes security criteria that member companies must comply with in order to sustain its program certification and reap the importation benefits of program participation. In turn, the C-TPAT member company must ensure their global suppliers, manufacturers and transportation providers (referred to as business partners) are compliant with the security criteria set forth in the C-TPAT program. A written and verifiable process of validating a business partner's security compliance and a risk assessment of all business partners is required within the C-TPAT and other governmental programs. Other government-promulgated guidelines for becoming a C-TPAT Business Partner are as follows:

“Importers must require their business partners to demonstrate that they are meeting C-TPAT security criteria via written/electronic confirmation;” and

“Based on a documented risk assessment process, non-C-TPAT eligible business partners must be subject to verification of compliance with C-TPAT security criteria by the importer.”

The present invention will serve this function.

With increased security measures on cargo entering the United States, C-TPAT certification is vital to companies that depend on moving freight quickly into the country. However, many companies who are either already C-TPAT certified or are considering becoming certified struggle with the demands of collecting and reporting business partner data to comply with C-TPAT regulations. Thus there is a need for a means to aid in eliciting information relevant to a C-TPAT inquiry and producing a result indicative of degree of C-TPAT compliance.

The present invention is a web based supplier risk analytics tool that provides a means for corporations to comply with critical program components set forth by multiple governmental supply chain security programs. The invention can measure and quantify the inherent risk(s) and percentage of compliance for a participating member's supplier base with programs such as the U.S. Customs Trade Partnership Against Terrorism (C-TPAT) program, and in other embodiments, the European Union's Authorized Economic Operator program and Canada's Partners in Participation program. In an embodiment, the invention can provide a risk rating or Supplier Risk Index score to a firm's outsourced suppliers, manufacturers and transportation providers.

### Risk Assessment Methodologies:

When member companies elect to use the present invention, all of their business partners will receive electronic communications to enroll into the module tool. The tool will ask specific questions as they pertain to the business partner's roll with the participating C-TPAT member company. Details such as country of origin, manufacturing weights, volumes and shipping details are captured in the module. Lastly, the business partner will complete an on line questionnaire that will determine the level of compliance that the business partner is for the respective government supply chain security program.

Based on a number of risk variables associated with the business partner, the module will rate the business partner's supply chain risk. The module uses a proprietary risk algorithm to determine the amount of exposure present with an enrolled business partner.

The module program will measure, assess and report two key risk equations:
1. Supplier Risk Index: A five panel risk rating ranging from low to severe which measures a business partner's complete supply chain exposures
2. Country Risk Index: A five panel risk rating ranging from low to severe which measures the severity and level of anti-Western terrorism exposures associated with the country a business partner is operating within

When considering this background section, the disclosure and claims herein should not be limited by the deficiencies of the prior art. In other words, the solution of those deficiencies is not a critical limitation of any claim unless otherwise expressly noted in that claim. Moreover, while this background section is presented as a convenience to the reader who may not be of skill in this art, it will be appreciated that this section is too brief to attempt to accurately and completely survey the prior art. The preceding background description is thus a simplified and anecdotal narrative and is not intended to replace printed references in the art. To the extent an inconsistency or omission between the demonstrated state of the printed art and the foregoing narrative exists, the foregoing narrative is not intended to cure such inconsistency or omission. Rather, applicants would defer to the demonstrated state of the printed art.

### BRIEF DESCRIPTION OF THE INVENTION

Disclosed is an internet based module which aids in managing the process of becoming C-TPAT compliant and which can produce an evaluation of the degree of C-TPAT compliance associated with a particular business partner. Whether an organization is already C-TPAT certified, or simply compiling the necessary data and “ramping up” for certification, the invention disclosed herein can simplify and streamline the time-consuming and complex task of obtaining, managing and reporting business partner risk data.

It is web-based and thus information can be checked or entered anywhere at anytime, and thus business partners can access the tool from any computer with Internet access, from anywhere in the world, at any time. The present invention makes use of a global cargo loss data and threat analyses to meaningfully gauge the potential risk of suppliers worldwide.

The invention disclosed herein also helps to control the cost of C-TPAT certification. Because it centralizes the location and deposit of information, it eliminates human collection and consolidation and other steps required before the collected data can be analyzed and thus the cost of C-TPAT compliance is lowered, helping to defray the costs involved in compiling and maintaining C-TPAT certification data. With the present invention, the cost of compliance can be easily apportioned as the parties wish, the option of paying for business partner assessments or leaving the cost up to the business partner.

The web based nature of the compliance module facilitates the communication between the company and the business partner, enabling the company to send the completion request to a Business Partner, with periodic reminders to complete or finish completion of the questionnaires. Notification of non-compliant partners can be sent. Business partner data can be analyzed individually, or it can be analyzed in a side-by-side fashion with other business partners. Furthermore, reports on individual business partners or comparative analyses can be generated.

### BRIEF DESCRIPTION OF THE DRAWINGS

FIG. 1: An example of a Supplier Risk algorithm: Basic formula

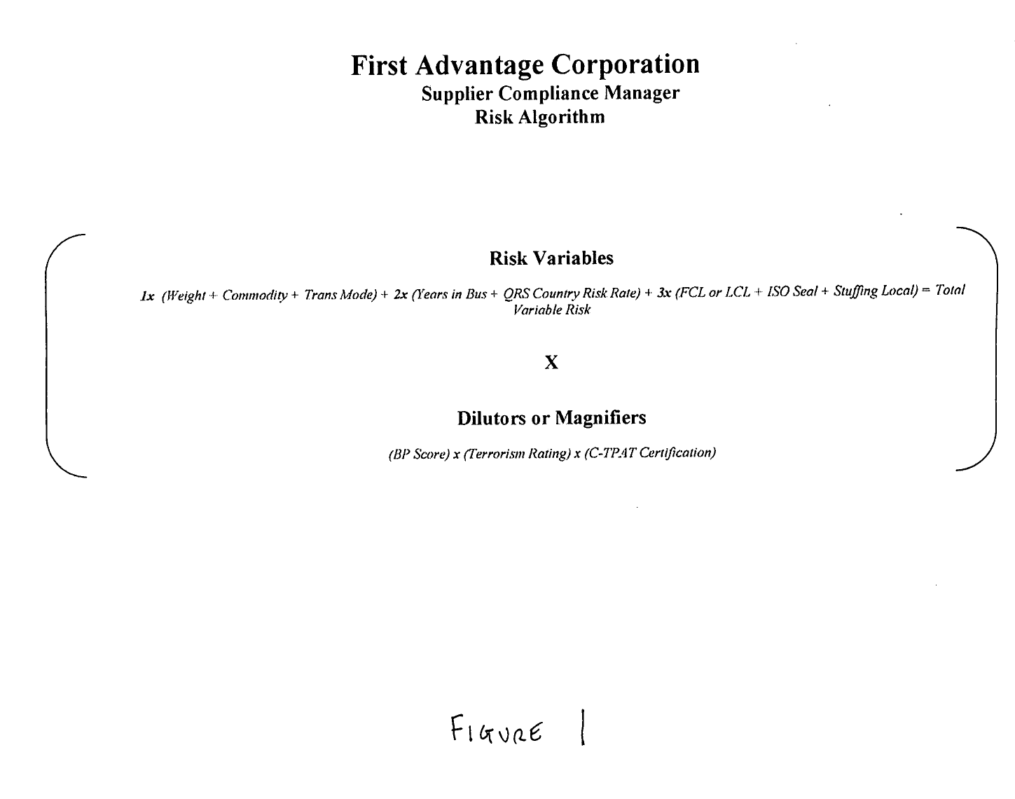

FIG. 2: An example of a Supplier Risk algorithm: Explication of variables weighted by 1

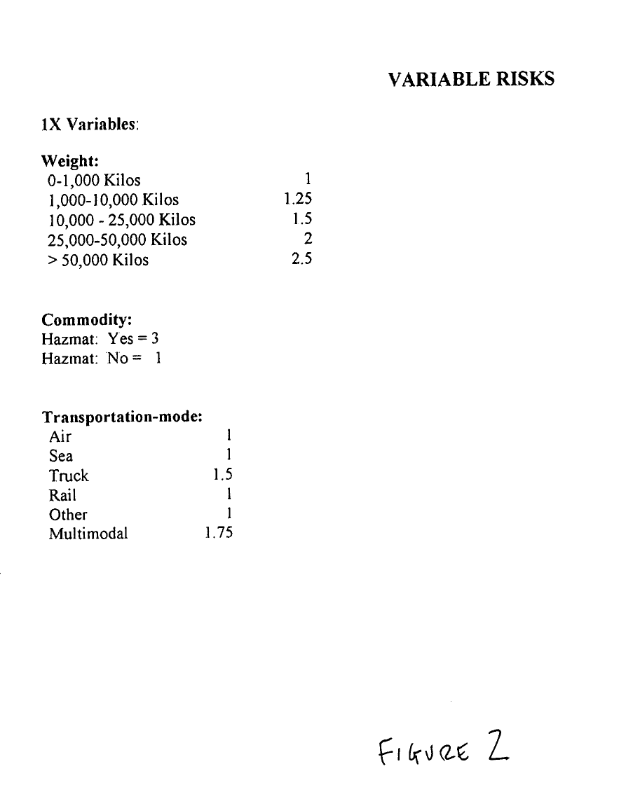

FIG. 3: An example of a Supplier Risk algorithm: Explication of variables weighted by 2

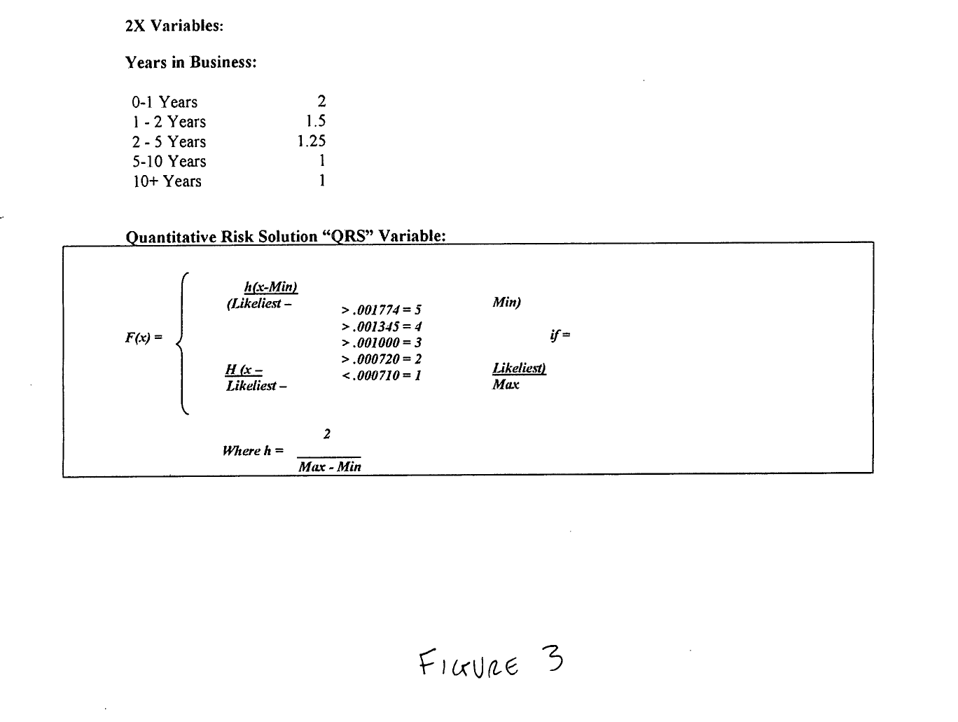

FIG. 4: An example of a Supplier Risk algorithm: Explication of variables weighted by 3

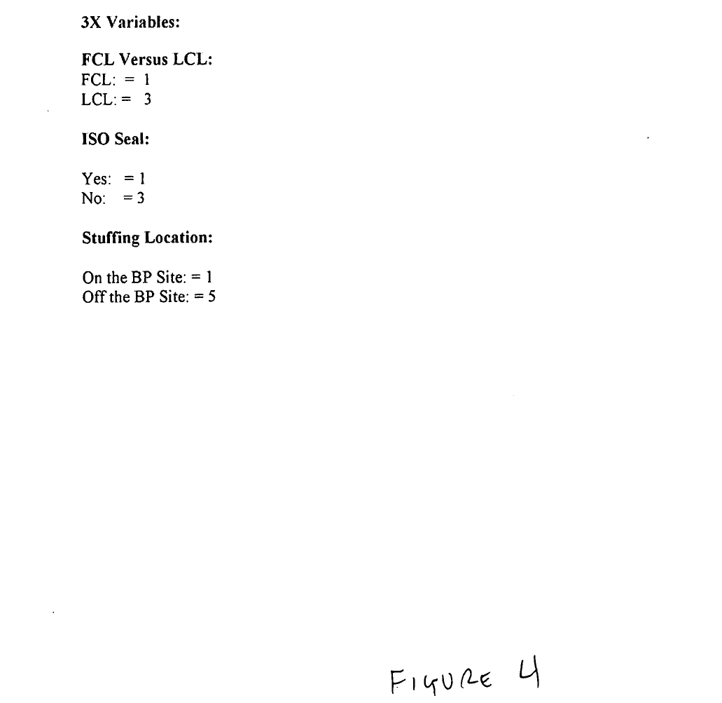

FIG. 5: An example of a Supplier Risk algorithm: Explication of risk magnifiers or dilutor

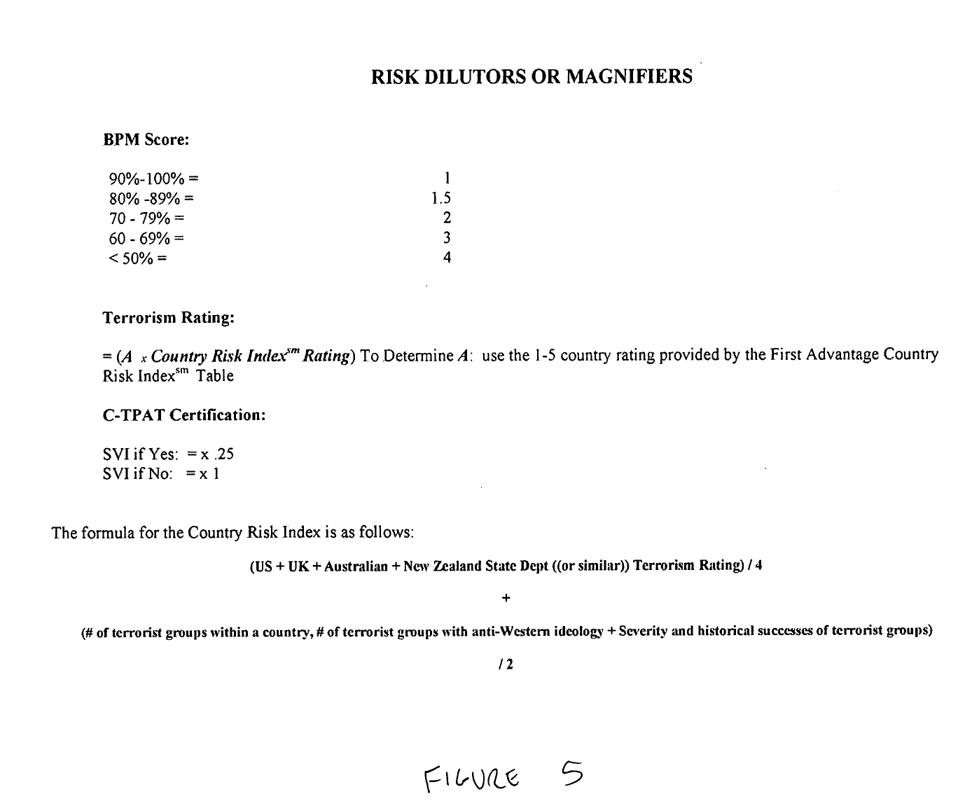

### DESCRIPTION OF THE PREFERRED EMBODIMENTS

Data Collection

The present inventive process enables the collection of complete, relevant data from business partners. It requires a business partner to log in to a portal and complete a “company profile” which gives the module information which allows it to assign the company to one of six different company types. The answers to the company profile allow the module to narrow the field of questions down to one of six, and the business partner will then be presented with one of six different potential self-assessment questionnaires. The questionnaire will be based upon the C-TPAT-specified topics for the particular business type according to the answers to the initial questions. Such a targeted approach reduces the amount of time the business partner must spend supplying their information, while also ensuring that the information collected is pertinent and applicable to the C-TPAT certification and security needs of the requestor. Risk variables are collected from the self-assessment questionnaires. Examples of risk variables may include location risk evaluators, such as country, city or postal code. Examples of other types of risk variables can be related to the commodity involved, such as the weight of the good, the value of the good, as well as whether or not the good is a hazardous material.

In one embodiment, the module comprises reminders which are set to remind the requestor to follow up with specific partners who have not completed the entry of their data those business partners who have not completed their entry to do so. In an additional embodiment, the module comprises a reminding system which reminds the requester and/or the data entrant exactly where in the entry process the entrant stopped during a prior data entry session. In other embodiments, the module reminds the requestor to request updates on an ongoing basis, with, optionally, a customizable timeframe.

Risk Assessment Scoring

In addition to the raw data provided by the business partner, the module utilizes risk data, which can be either or both governmental or private, to assign each business partner three “scores” to give an additional perspective on their relative risk or safety based on a number of factors:

Security Assessment Scoring uses the data provided during the self-assessment to rank the business partner against governmental C-TPAT standards: In essence, each of a list of different types of business partners must comply with certain inviolate standards in order to be eligible. The compliance with nonmandatory but highly desirable government standards is also tallied. Results are presented as easy-to-understand percentages in three separate categories: “Musts” are standards that must be met in order for the business partner to be used by a requestor seeking certification. “Shoulds” are standards that are not required for C-TPAT but that are recommended best practices for a business partner. Below are some examples of threshold “must” and “should” numbers as they apply to particular types business partners. The given “should” numbers are the threshold for certification.

| | |
|---|---|
| Foreign manufacturer | 49 must/27 should |
| US Customs Broker | 46 must/31 should |
| Highway Carrier | 70 must/42 should |
| Rail Carrier | 40 must/21 should |
| Sea Carrier | 52 must/22 should |
| US Importer | 46 must/24 should |

In one embodiment, Security Assessment scoring can include questions not required by the government, but specific to the requester. The Custom category allows the requestor to devise its own questions to accurately track business partner compliance with the requestor's internal supply chain standards.

Supplier Risk Index uses a supplier risk algorithm to measure the risk of un-manifested cargo introduction into the supply chain based on a weighted sum of components which can comprise (along with their weights): 1×-weighted factors: commodity weight, commodity HazMat status, and transportation mode; 2×-weighted factors: Business Partner years in the business and QRS Country Risk (supply chain disruption) Rate; and 3×-weighted factors: full container load (FCL) versus less than full container load (LCL), presence or absence of ISO seal, and stuffing location (on or off BP site).

The sum is multiplied by the product of BP score, terrorism rating, and C-TPAT certification.
Country Risk Index
Supply Chain Disruption (QRS)
Supply Chain Structure
Security Infrastructure
more

Country Risk Index measures terrorism activity by country. In one embodiment, the assessment is based upon an active repository consisting of frequently updated information based on known terrorist groups (over 800) and their geographic bases in over 200 countries, as well as the frequency and success of each in interrupting commerce. In another embodiment, the information is augmented and developed by terrorism modeling.

In one embodiment, the module features a variety of reporting tools to help the requester efficiently track and assess business partner information:
The module allows quick and easy access to information on the percentage of business partners who've completed their assessments, average participant score, and percentage of C-TPAT business partners' Status Verification Interface
In one embodiment, the module can prepare a Business Partner Risk Report giving the “big picture” risk level for each business partner, while the Business Partner Full Report allows deeper investigation into the information provided in the self-assessment.
In one embodiment the module has access to the same information indicated in the Country Risk Index above, and the module can prepare Country and Global Risk Reports which allow the requestor to quickly assess the risk level in each country and take this information into account when selecting business partners and planning supply routes.

### Reports:

The module will store all of a C-TPAT member company's business partner security profiles and enable the member company to easily identify which suppliers and countries present the most risk. Functionality of the tool will allow C-TPAT member companies to develop geographical plotting and mapping of what countries their partners are located within and the countries risk level. Further, the tool will allow the C-TPAT member company to communicate via email to each of their business partners in the native language of the business partner's choice.

All steps are executed by a computer or other computing device having a processor executing computer-executable instruction read from a computer-readable medium, e.g., a magnetic or optical disk, tape, RAM, ROM, hard drive, etc. As used herein, the term “computer-readable medium” includes human-tangible media such as those listed above and others, and excludes human-intangible media (e.g., acoustic waves, RF waves, electrical signal waves, etc.) unless otherwise noted.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1) Method for quantitatively evaluating, for C-TPAT purposes, the risk of doing business with a business partner, said method comprising:
a) requiring the business partner to complete a first questionnaire with regard to the business partner's type of business;
b) requiring the business partner, to complete a second questionnaire based upon the answers to the questionnaire in a), with regard to risk factors associated with the type of business determined from the answers to the questions in the questionnaire of part a).
c) deriving a country risk index based upon the answers gathered in a) and b) of the business partner's operation;
d) deriving a supplier risk index based upon the answers to the questions in part b);
e) outputting a risk score with respect to c) above;
f) outputting a risk score with respect to d) above; and
g) developing a business partner security profile.

2) A method as in claim 1 wherein there are six possible types of business in a).

3) A method as in claim 1 wherein the country risk calculated from variables which comprise at least one measure of the severity and level of anti-Western terrorism exposures associated with the country a business partner is operating within.

4) A method as in claim 3 wherein the country risk comprises accounting for the number of terrorist groups operating within a country, the number of terrorist groups with anti-Western ideology, and the historical success of attempts by the groups to disrupt commerce.

5) A method as in claim 3 wherein the supplier risk index is calculated from physical commodity details; supplier experience and country risk details; packing and packaging details; and terrorist group presence, anti-western cant, and record of success of attacks;

6) A method as in claim 4 wherein the supplier risk index is calculated from physical commodity details; supplier experience and country risk details; packing and packaging details; and terrorist group presence, anti-western cant, and record of success of attacks;

7) A method as in claim 1 which further comprises a security assessment scoring.

8) A method as in claim 6 which further comprises a security assessment scoring.

9) A computer-readable medium having thereon computer-executable instructions for quantitatively evaluating, for C-TPAT purposes, the risk of doing business with a business partner; the instructions comprising:
a) instructions for receiving business-partner provided answers to a business-type questionnaire, said questionnaire and answers stored in a computer-readable electronic media;
b) instructions for selecting a second questionnaire stored in a computer-readable electronic media based upon the answers to the first questionnaire, said second questionnaire stored in a computer-readable electronic media;
c) instructions for receiving business-partner provided answers the questions in said second questionnaire with regard to risk factors associated with the type of business determined from the answers to the questions in the questionnaire of part a), the answer to the questions in said second questionnaire stored in a computer-readable electronic media.
d) instructions for deriving a country risk index based upon the answers received in b), an optionally a);
e) instructions for deriving a supplier risk index based upon the answers to the questions in part b);
f) instructions for outputting a risk score with respect to d) above;
g) instructions for outputting a risk score with respect to e) above; and
h) instructions for developing a business partner security profile.

10) A computer readable medium as in claim 9 wherein there are six different second questionnaires.

11) A computer readable medium as in claim 9 wherein the country risk calculated from variables which comprise at least one measure of the severity and level of anti-Western terrorism exposures associated with the country a business partner is operating within.

12) A computer readable medium as in claim 9 wherein calculation of the country risk comprises accounting for the number of terrorist groups operating within a country, the number of terrorist groups with anti-Western ideology, and the historical success of attempts by the groups to disrupt commerce.

13) A computer readable medium as in claim 11 wherein the supplier risk index is calculated from physical commodity details; supplier experience and country risk details; packing and packaging details; and terrorist group presence, anti-western cant, and record of success of attacks;

14) A computer readable medium as in claim 12 wherein the supplier risk index is calculated from physical commodity details; supplier experience and country risk details; packing and packaging details; and terrorist group presence, anti-western cant, and record of success of attacks;

15) A computer readable medium as in claim 9 which further comprises instructions for a security assessment scoring.

16) A computer readable medium as in claim 14 which further comprises instructions for a security assessment scoring.
